(19) United States
(12) Patent Application Publication
(10) Pub. No.: US 2023/0094572 A1
(43) Pub. Date: Mar. 30, 2023

(54) Systems and Methods for Passive Calibration in Eye-Tracking System

(71) Applicant: EyeTech Digital Systems, Inc., Mesa, AZ (US)

(72) Inventor: Robert C. Chappell, Mesa, AZ (US)

(21) Appl. No.: 17/486,325

(22) Filed: Sep. 27, 2021

(51) Int. Cl. G06F 3/01; H04N 5/33

(52) U.S. Cl. CPC G06F 3/013; H04N 5/33

(57) ABSTRACT

An eye-tracking calibration system includes an infrared illumination source and a camera assembly configured to receive infrared light reflected from a user's face during activation of the infrared illumination source and to produce image data associated therewith. A processor communicatively coupled to the camera assembly and the illumination source is produces eye-tracking data based on the image data during real-time use of the system by the user. The processor senses the selection of a user interface element by the user during the real-time use, applies an animation to the selected user interface element, determines a gaze point of the user during the animation, and derives calibration data based on the determined gaze point.

### TECHNICAL FIELD

The present invention relates, generally, to eye-tracking systems and methods and, more particularly, to the use of passive calibration in connection with such eye-tracking systems.

### BACKGROUND

Eye-tracking systems, such as those used in conjunction with desktop computers, laptops, tablets, head-mounted displays and other such computing devices that include a display, generally incorporate one or more illuminators (e.g., near-infrared LEDs) for directing infrared light to the user's eyes, and a camera assembly for capturing, at a suitable frame rate, reflected images of the user's face for further processing. By determining the relative locations of the user's pupils (i.e., the pupil centers, or PCs) and the corneal reflections (CRs) in the reflected images, the eye-tracking system can accurately predict the user's gaze point on the display.

Calibration procedures for such eye-tracking systems are often\ undesirable in a number of respects. For example, calibration is traditionally performed as a separate, initial step in preparation for actual use of the system. This process is inconvenient for users, and may require a significant amount of time for the system to converge to suitable calibration settings. In addition, once such a calibration process is completed at the beginning of a session, the eye-tracking system is generally unable to adapt to different conditions or user behavior during that session.

Systems and methods are therefore needed that overcome these and other limitations of prior art eye-tracking calibration settings.

### SUMMARY OF THE INVENTION

Various embodiments of the present invention relate to systems and methods for performing passive calibration in the context of an eye-tracking system. More particularly, in order to assist in gaze-point calibration, a relatively dramatic (i.e., “eye-catching”) animation—e.g., a change in orientation, form, size, color, etc.—is applied to icons such as menu items, selection rectangles, and the like when they are selected by the user during normal operation.

The animation inevitably (and perhaps unconsciously) draws the attention of the user's eyes, even if the user's gaze point was initially offset from the actual location of the icon due to calibration errors. The system observes the user's eyes during this interval and re-calibrates based on the result. In some embodiments, the animation is simplified and/or reduced in duration as over time as the calibration becomes more accurate.

In this way, calibration to occur in the background (and adapt over time), rather being performed during a specific calibration procedure. Usability is particularly increased for children or others who may have difficulty initiating and completing traditional calibration procedures.

### BRIEF DESCRIPTION OF THE DRAWING FIGURES

The present invention will hereinafter be described in conjunction with the appended drawing figures, wherein like numerals denote like elements, and:

FIG. 1 is a conceptual overview of a computing device and eye-tracking system in accordance with various embodiments;

FIGS. 2A and 2B are front and side views, respectively, of a user interacting with an eye-tracking system in accordance with various embodiments;

FIG. 2C illustrates the determination of pupil centers (PCs) and corneal reflections (CRs) in accordance with various embodiments;

FIG. 3 illustrates, for the purpose of explaining the present invention, an example user interface display with distinct regions for selection by a user;

FIGS. 4-7 illustrate four example animation modes in accordance with various embodiments;

FIG. 8 is a flowchart illustrating a passive calibration method in accordance with various embodiments; and

FIG. 9 illustrates the convergence of eye gaze points over time as calibration is performed during operation of the user interface.

### DETAILED DESCRIPTION OF PREFERRED

### Exemplary Embodiments

The present subject matter relates to systems and methods for performing eye-tracking calibration during normal operation (in medias res) rather than during a dedicated, preliminary calibration step. As described in further detail below, a predetermined (or variable) animation is applied to icons such as menu items, selection rectangles, and the like when they are selected by the user during normal operation, which draws the users gaze toward that user interface element, during which the system can track the user's eye movements, allowing it to improve its calibration settings. As a preliminary matter, it will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to eye-tracking algorithms, image sensors, IR illuminators, calibration, and digital image processing may not be described in detail herein.

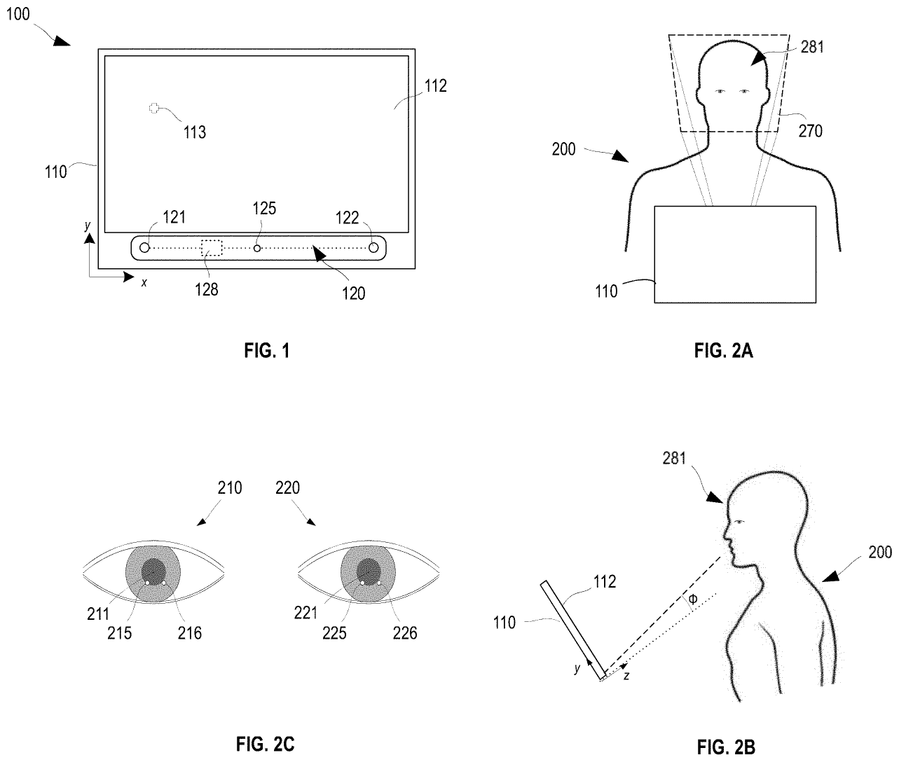

Referring first to FIG. 1 in conjunction with FIGS. 2A-2C, the present invention may be implemented in the context of a system 100 that includes a computing device 110 (e.g., a desktop computer, tablet computer, laptop, smart-phone, head-mounted display, television panels, dashboard-mounted automotive systems, or the like) having a display 112 and an eye-tracking assembly 120 coupled to, integrated into, or otherwise associated with device 110. It will be appreciated that embodiments of the present invention are not limited to the particular shape, size, and type of computing devices 110 illustrated in the figures.

Eye-tracking assembly 120 includes one or more infrared (IR) light sources, such as light emitting diodes (LEDs) 121 and 122 (alternatively referred to as “L1” and “L2” respectively) that are operable to illuminate the facial region 281 of a user 200, while one or more camera assemblies (e.g., camera assembly 125) are provided for acquiring, at a suitable frame-rate, reflected IR light from user's facial region 281 within a field-of-view 270.

Eye-tracking assembly may include one or more processors (e.g., processor 128) configured to direct the operation of LEDs 121, 122 and camera assembly 125. Eye-tracking assembly 120 is preferably positioned adjacent to the lower edge of screen 112 (relative to the orientation of device 110 as used during normal operation).

System 100, utilizing computing device 110 (and/or a remote cloud-based image processing system) determines the pupil centers (PCs) and corneal reflections (CRs) for each eye—e.g., PC 211 and CRs 215, 216 for the user's right eye 210, and PC 221 and CRs 225, 226 for the user's left eye 220. The system 100 then processes the PC and CR data (the “image data”), as well as other available information (e.g., head position/orientation for user 200), and determines the location of the user's gaze point 113 on display 112. The gaze point 113 may be characterized, for example, by a tuple (x, y) specifying linear coordinates (in pixels, centimeters, or other suitable unit) relative to an arbitrary reference point on display screen 112. The determination of gaze point 113 may be accomplished through calibration methods (as described herein) and/or the use of eye-in-head rotations and head-in-world coordinates to geometrically derive a gaze vector and its intersection with display 112, as is known in the art.

In general, the phrase “eye-tracking data” as used herein refers to any data or information directly or indirectly derived from an eye-tracking session using system 100. Such data includes, for example, the stream of images produced from the users' facial region 281 during an eye-tracking session (“image data”), as well as any numeric and/or categorical data derived from the image data, such as gaze point coordinates, corneal reflection and pupil center data, saccade (and micro-saccade) information, and non-image frame data. More generally, such data might be include information regarding fixations (phases when the eyes are stationary between movements), saccades (rapid and involuntary eye movements that occur between fixations) scan-path (series of short fixations and saccades alternating before the eyes reach a target location on the screen), duration (sum of all fixations made in an area of interest), blink (quick, temporary closing of eyelids), and pupil size (which might correlate to cognitive workload, etc.).

In some embodiments, image data may be processed locally (i.e., within computing device 110 and/or processor 128) using an installed software client. In some embodiments, however, eye tracking is accomplished using an image processing module remote from computing device 110—e.g., hosted within a cloud computing system communicatively coupled to computing device 110 over a network (not shown). In such embodiments, the remote image processing module performs all or a portion of the computationally complex operations necessary to determine the gaze point 113, and the resulting information is transmitted back over the network to computing device 110. An example cloud-based eye-tracking system that may be employed in the context of the present invention is illustrated in U.S. patent application Ser. No. 16/434,830, entitled “Devices and Methods for Reducing Computational and Transmission Latencies in Cloud Based Eye Tracking Systems,” filed Jun. 7, 2019, the contents of which are hereby incorporated by reference.

In traditional eye-tracking systems, a dedicated calibration process is initiated when the user initially uses the system or begins a new session. This procedure generally involves displaying markers or other graphics at preselected positions on the screen in a sequential fashion—e.g., top-left corner, top-right corner, bottom-left corner, bottom-right corner, center, etc.—during which the eye-tracking system observes the gaze point of the user. Due to random error and other factors (which may be specific to the user), the gaze point will generally diverge from the ground-truth positional value. This error can be used to derive spatial calibration factors based on various statistical methods that are well known in the art. During normal operation, the calibration factors can be used to derive a maximum-likelihood gaze point, or the like.

As described above in the Background section, conventional calibration procedures are time consuming and annoying to the user. Accordingly, in accordance with various aspects of the present invention, calibration is performed adaptively and in real-time while the eye-tracking system is observing the user (with no dedicated calibration procedure required). Specifically, an animation is applied to icons such as menu items, selection rectangles, and the like when they are selected by the user, which draws the users gaze toward that user interface element. During this animation event, the system can track the user's eye movements, allowing it to improve its calibration settings. The animation may be applied immediately, or after some predetermined delay. Further, the animation may take place during any convenient time interval. This delay and animation time may adaptively change over time—i.e., depending upon the quality of the calibration data. For example, if the calibration data is of sufficient quality/quantity, then the animations may not be needed during a particular session (as described in further detail below).

As used herein, the phrase “calibration data” means any suitable parameters, numeric values, or the like that can be used to provide correction of measured data and/or perform uncertainty calculations regarding user gaze coordinates. For example, calibration data may simply include x-axis and y-axis offset values (i.e., difference between expected and actual values). In other cases, more complex polynomial coefficients, machine learning models, or other mathematical constructs may be used.

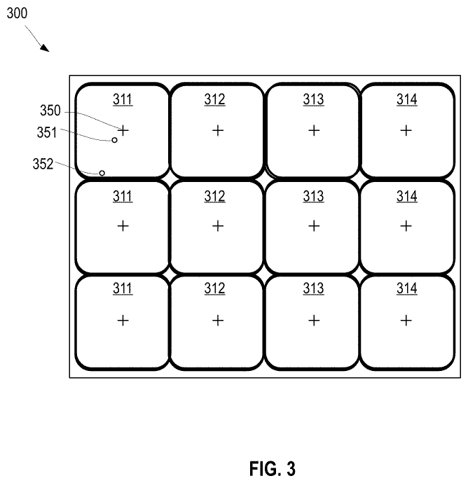

FIG. 3 illustrates, for the purpose of explaining the present invention, an example user interface display with distinct regions or user interface elements for selection by a user. That is, the display screen may be partitioned into a number of discrete elements (e.g., 311-314), which need not be square or rectangular (as illustrated in this example). As mentioned above, when a user is attempting to direct their gaze point to, for example, element 311 in the upper left corner, the computed user gaze point will typically be different from the ideal center 350 of element 311, and might be located near the center (at point 351) or toward the edge of the region at point 352. The goal of the present invention is to draw the user's eyes closer to the center 350 of region 311, and thereby improve the calibration settings through the use of animated elements.

A wide variety of animation modes may be used, but in a preferred embodiment the animation is sufficiently dramatic that it is very likely to be observed by the user. Stated another way, the user interface element selected by the user is preferably transformed qualitatively and/or quantitatively to the extent that the user's eyes are drawn to that user interface element (preferably, near the center of the element).

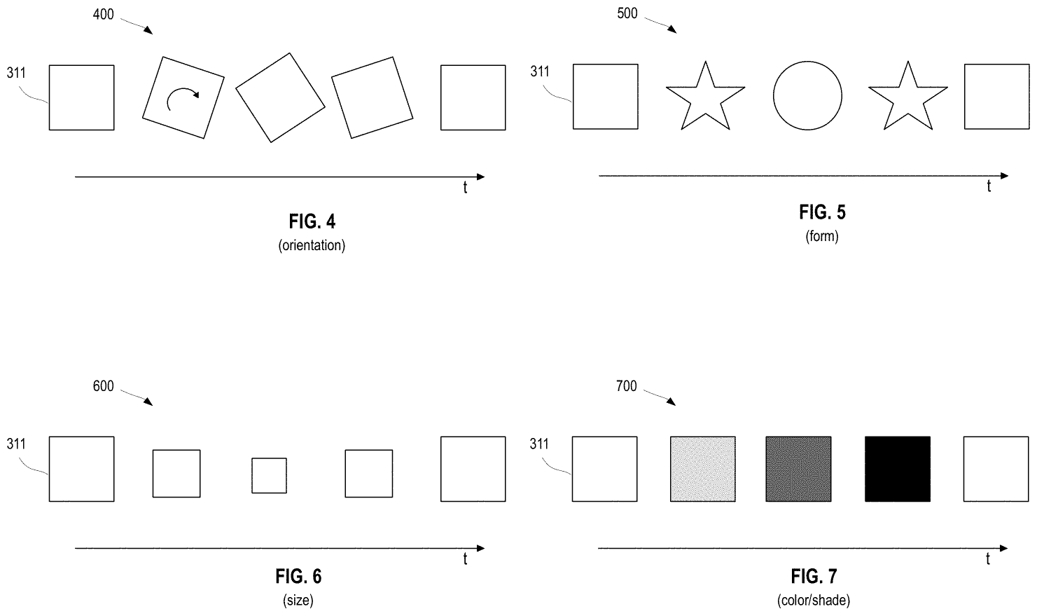

FIGS. 4-7 illustrate four example animation modes in accordance with various embodiments (in which the horizontal axis corresponding to time). FIG. 4 illustrates an animation 400 in which element 311 undergoes a pure rotational transformation (which may involve any desired number of rotations). FIG. 5 illustrates an animation 500 in which element 311 undergoes a change in form (in this case, from a square to a star, to a circle, etc.). Again, any number of shapes and transformation speeds may be used. FIG. 6 shows an animation 600 in which element 311 changes size over time (growing smaller than increasing back to its original size). Finally, FIG. 7 shows an animation 700 in which element 311 changes in color, shade, or RGB value over time.

It will be appreciated that the examples shown in FIGS. 4-7 are in no way limiting, and that a wide range of animations may be used in connection with the present invention. In addition, the various animations shown in FIGS. 4-7 may be combined. For example, element 311 may rotate as shown in FIG. 4 while changing in size as shown in FIG. 6. Or, for example, element 311 may change in form as shown in FIG. 5 while changing in shade/color as shown in FIG. 7.

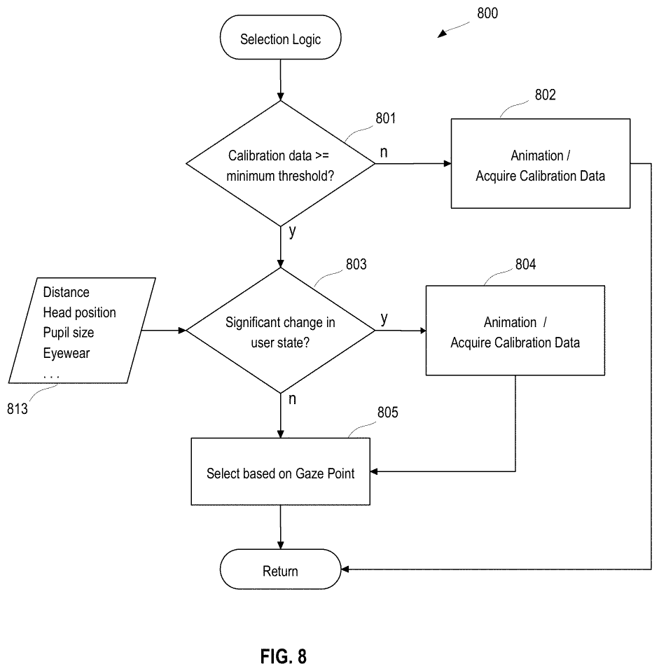

FIG. 8 is a flowchart illustrating a passive calibration method 800 in accordance with various embodiments. More particular, the selection logic begins at step 801, in which it is determined whether the calibration data quality (or quantity) is greater than or equal to a minimum threshold value. This threshold value may relate to a confidence interval, the number of acquired data points, or any other appropriate metric known in the art.

If the calibration data is not above the minimum threshold (“N” branch), then the system attempts to acquire calibration data through the use of animation 802, as described above. If, at step 801, the calibration data was found to be above the minimum threshold (“Y” branch), then processing continues to step 803, in which it is determined whether there has been a significant change in user state—e.g., has the user moved farther from the screen, changed pupil sizes, donned glasses, etc., as indicated by input 813. If so, then at step 804 the system toggles to a mode in which animation is used to acquire calibration data, as described above; if not, then processing continues to step 805, and the selection (of a user interface element) is made based on the current gaze point in view of the existing calibration data.

While the various examples described above relate to the case in which the system determines inaccuracies within a user interface element (e.g., within the correct rectangular region that the user desires to select), the invention may also sense inaccuracies even in cases in which the user is gazing at a user interface element that is remove from the desired element (i.e., when the user is not even looking at the correct icon of the like).

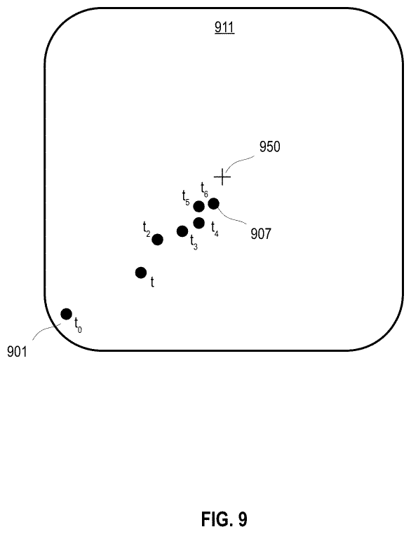

FIG. 9 illustrates the convergence of eye gaze points over time as calibration is performed during operation of the user interface. Specifically, an element 911 is shown having a center 950. It is contemplated that, as calibration proceeds (and animations are used to further refine these values), the user's computed eye gaze location will tend to converge toward center 950. That is, at time to, the user's computed eye gaze may start at point 901 near the lower left edge of the element 911. Over time (t₁-t₆), the user's computed eye gaze will converge closer to center 950, such as point 907.

Embodiments of the present disclosure may be described in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, field-programmable gate arrays (FPGAs), Application Specific Integrated Circuits (ASICs), logic elements, look-up tables, or the like, which may carry out a variety of functions under the control of one or more microprocessors or other control devices.

In addition, the various functional modules described herein may be implemented entirely or in part using a machine learning or predictive analytics model. In this regard, the phrase “machine learning” model is used without loss of generality to refer to any result of an analysis that is designed to make some form of prediction, such as predicting the state of a response variable, clustering patients, determining association rules, and performing anomaly detection. Thus, for example, the term “machine learning” refers to models that undergo supervised, unsupervised, semi-supervised, and/or reinforcement learning. Such models may perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models.

Any of the eye-tracking data generated by system 100 may be stored and handled in a secure fashion (i.e., with respect to confidentiality, integrity, and availability). For example, a variety of symmetrical and/or asymmetrical encryption schemes and standards may be employed to securely handle the eye-tracking data at rest (e.g., in system 100) and in motion (e.g., when being transferred between the various modules illustrated above). Without limiting the foregoing, such encryption standards and key-exchange protocols might include Triple Data Encryption Standard (3DES), Advanced Encryption Standard (AES) (such as AES-128, 192, or 256), Rivest-Shamir-Adelman (RSA), Twofish, RC4, RC5, RC6, Transport Layer Security (TLS), Diffie-Hellman key exchange, and Secure Sockets Layer (SSL). In addition, various hashing functions may be used to address integrity concerns associated with the eye-tracking data.

In addition, those skilled in the art will appreciate that embodiments of the present disclosure may be practiced in conjunction with any number of systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the terms “module” or “controller” refer to any hardware, software, firmware, electronic control component, processing logic, and/or processor device, individually or in any combination, including without limitation: application specific integrated circuits (ASICs), field-programmable gate-arrays (FPGAs), dedicated neural network devices (e.g., Google Tensor Processing Units), electronic circuits, processors (shared, dedicated, or group) configured to execute one or more software or firmware programs, a combinational logic circuit, and/or other suitable components that provide the described functionality.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. An eye-tracking calibration system comprising:
an infrared illumination source;
a camera assembly configured to receive infrared light reflected from a user's face during activation of the infrared illumination source and to produce image data associated therewith; and
a processor communicatively coupled to the camera assembly and the illumination source, the processor configured to produce eye-tracking data based on the image data during real-time use of the system by the user;
wherein the processor is further configured to sense the selection of a user interface element by the user during the real-time use, apply an animation to the selected user interface element to cause the user' s gaze point to move toward the selected user interface element, determine a gaze point of the user during the animation, and derive calibration data based on the determined gaze point.

2. The eye-tracking calibration system of claim 1, wherein the animation includes one or more of: changing the orientation of the user interface element, changing the form of the user interface element, changing the size of the user interface element, and changing the color of the user interface element.

3. The eye-tracking calibration system of claim 1, wherein the system determines whether to apply the animation based on whether the calibration data is greater than or equal to a predetermined minimum threshold.

4. The eye-tracking calibration system of claim 1, wherein the system determines whether to apply the animation based on whether there has been a significant change in user state.

5. The eye-tracking calibration system of claim 4, wherein the user state is characterized by at least one of: distance from the display, head position, pupil size, and the presence of eyewear on the user.

6. The eye-tracking calibration system of claim 1, wherein the system is capable of deriving calibration data in the event that the user's gaze point is within a second user interface element.

7. A method of performing calibration of an eye-tracking system, the method comprising:
receiving, with a camera assembly, infrared light reflected from a user's face during activation of an infrared illumination source to produce image data associated therewith; and
producing eye-tracking data based on the image data during real-time use of the system by the user;
sensing the selection of a user interface element by the user during the real-time use;
applying an animation to the selected user interface element to cause the user's gaze point to move toward the selected user interface element;
determining a gaze point of the user during the animation, and
deriving calibration data based on the determined gaze point.

8. The method of claim 7, wherein the animation includes one or more of: changing the orientation of the user interface element, changing the form of the user interface element, changing the size of the user interface element, and changing the color of the user interface element.

9. The method of claim 7, wherein the system determines whether to apply the animation based on whether the calibration data is greater than or equal to a predetermined minimum threshold.

10. The method of claim 7, wherein the system determines whether to apply the animation based on whether there has been a significant change in user state.

11. The method of claim 10, wherein the user state is characterized by at least one of: distance from the display, head position, pupil size, and the presence of eyewear on the user.

12. The method of claim 7, wherein calibration data is derived in the event that the user's gaze point is within a second user interface element.

13. Non-transitory media bearing computer-readable instructions configured to instruct a processor to perform the steps of:
receive, with a camera assembly, infrared light reflected from a user's face during activation of an infrared illumination source to produce image data associated therewith; and
produce eye-tracking data based on the image data during real-time use of the system by the user;
sense the selection of a user interface element by the user during the real-time use;
apply an animation to the selected user interface element to cause the user's gaze point to move toward the selected user interface element;
determine a gaze point of the user during the animation, and
derive calibration data based on the determined gaze point.

14. The non-transitory media of claim 13, wherein the animation includes one or more of: changing the orientation of the user interface element, changing the form of the user interface element, changing the size of the user interface element, and changing the color of the user interface element.

15. The non-transitory media of claim 13, wherein the system determines whether to apply the animation based on whether the calibration data is greater than or equal to a predetermined minimum threshold.

16. The non-transitory media of claim 13, wherein the system determines whether to apply the animation based on whether there has been a significant change in user state.

17. The non-transitory media of claim 16, wherein the user state is characterized by at least one of: distance from the display, head position, pupil size, and the presence of eyewear on the user.

18. The non-transitory media of claim 13, wherein calibration data is derived in the event that the user's gaze point is within a second user interface element.
